(19) United States
(12) Patent Application Publication
(10) Pub. No.: US 2002/0150100 A1
(43) Pub. Date: Oct. 17, 2002

(54) Method and apparatus for adaptive frame fragmentation

(76) Inventors: Timothy Richard White, Palo Alto, CA (US); James L. Cunning, San Diego, CA (US); Eric L. Michelsen, Poway, CA (US); Harkiran Kaur, San Diego, CA (US)

Correspondence Address: Kevin J. Zimmer, Cooley Godward LLP, Five Palo Alto Square, 3000 El Camino Real, Palo Alto, CA, 94306-2155, US

(21) Appl. No.: 09/792,731

(22) Filed: Feb. 22, 2001

(51) Int. Cl. H04L 12/56

(52) U.S. Cl. 370/392; 370/444

(57) ABSTRACT

A system and method of transferring data through a network by adaptively fragmenting frames of information into subframes. The method contemplates receiving a first frame and a second frame at a first node of the network. The first frame is segmented into a fragmented frame comprised of at least a first subframe and a second subframe, and the first subframe transmitted to a second node of the network. Following transmission of the first subframe to the second node, the second frame is transmitted to the second node prior to transmission of the second subframe to the second node. A first identifying field is appended to the first subframe and a second identifying field is appended to the second subframe, the first and second identifying fields respectively indicating the relative position of the first subframe and the second subframe within the fragmented frame.

### FIELD OF THE INVENTION

The present invention relates generally to high-speed access networks supporting digital packet-based transport protocols, such as Digital Subscriber Loop (DSL) technology, and more specifically to a system and method for providing high-quality multimedia and data services over such access networks.

### BACKGROUND OF THE INVENTION

Increased use of the Internet has continued to provide an impetus for higher communication rates. In the corporate realm, the need for high-speed access or data rates is often met by dedicated high-speed links (perhaps T1/E1 frame relays) between a company and its Internet access provider. Users in the company typically utilize a local area network (LAN) to gain access to Internet routing infrastructure connected to the high-speed link. Unfortunately, residential users of the Internet are often not connected to such high-speed links, and frequently rely on standard analog or plain old telephone service (POTS) lines for access to the Internet.

The need to provide high-speed Internet access to residential users is ever increasing due to the availability of information, entertainment, and the like through the Internet's worldwide web (WWW) portion. For example, designers of web technology are constantly developing new ways to provide sensory experiences, including audio and video, to users of the WWW. As a consequence, higher-speed modems will be required to enable residential users to satisfactorily interact with the content and technologies being developed for the WWW. Unfortunately, analog or POTS line modems are presently only able to reach data rates of up to 56 kilobits per second (Kbps). These conventional analog modems transmit and receive information on POTS subscriber lines through the public switched telephone network (PSTN). The Internet access provider is also coupled to the PSTN and transmits and receives information through it to the subscriber line.

A variety of communication technologies are competing to provide high-speed access to residential users. For example, DSL, cable modem, satellite broadcast, wireless LAN, and fiber technologies have all been suggested. Of these approaches, only DSL technology can utilize existing POTS subscriber lines between residential users and the telephone company central offices or local exchanges.

DSL technology provides a physical layer protocol for communicating information across a POTS subscriber line at data rates exceeding those achievable using conventional analog modem technology and other physical layer protocols. One form of DSL is asymmetric digital subscriber line (ADSL) communication. ADSL communication involves transmitting data in one direction (typically towards the customer premises) at a greater data rate than data is transmitted in the other direction (typically towards the local exchange). There are also other known forms of DSL such as symmetric DSL (SDSL), high-speed DSL (HDSL) and very high-speed DSL (VDSL). These various forms of DSL are referred to generally herein as xDSL.

xDSL communication systems are generally implemented using a digital subscriber loop access multiplexer (DSLAM) located at a central office or other local exchange termination point of the PSTN. A DSLAM typically contains a number of xDSL termination units, or modems, that can establish an xDSL link and communicate xDSL protocol data across POTS subscriber lines. The xDSL termination units can be connected to the POTS subscriber lines via splitter devices that separate the xDSL data traffic from voice traffic on the telephone lines. Because an xDSL modem operates at frequencies higher than the voice-band frequencies, use of a splitter enables an xDSL modem to operate simultaneously with a voice-band modem or a telephone conversation over the same subscriber line. A splitter is similarly used at the customer premises to separate voice and xDSL data traffic and to provide the xDSL data traffic to an xDSL termination unit located at the remote customer premises. Once established, the xDSL link allows high-speed data communication to occur between the local exchange and the “customer premises equipment” (CPE) located at a remote customer site in the communication system.

The CPE typically includes an xDSL interface component that has an xDSL termination unit for terminating the xDSL link, as well as a buffer or other interface component between the xDSL termination unit and other CPE components. The xDSL interface may be implemented, for example, in the form of a network interface card (NIC) that interfaces between the xDSL link and a bus on a personal computer, workstation or other computing device. The xDSL interface can also form a component of a network router or bridge, such as an Ethernet router or bridge.

The xDSL physical layer may support various types of higher-layer data traffic. For example, data traffic may be carried in an asynchronous transfer mode (ATM) in which data ATM cells carry traffic. The xDSL physical layer may also support the transport of data traffic in a frame relay mode. In the frame relay mode data traffic is carried using frames formatted in accordance with the high-level data link control (HDLC) or other frame-based standard.

A frame relay network provides a user with multiple independent data links to one or more destinations. A frame relay network typically consists of a number of interconnected nodes, each of which are capable of receiving data from other nodes and forwarding that data through to yet other nodes. Nodes are interconnected by transmission paths, each of which supports one or more virtual circuits. Communication from one user to another can thus be made using the pre-defined network connections of the virtual circuits. The frame relay technique is described generally in CCITT recommendation I.233, and recommendation Q.922 describes the associated Link Access Procedure for Frame-Mode Bearer Services (LAPF). The protocol Q.922 specifies, among other things, the format of an address header providing for the addressing of the associated frame relay packet. For a more detailed description of the frame relay technique, reference is made to An Overview of Frame Relay Technology, Datapro Management of Data Communications, McGraw-Hill Incorporated, April 1991.

Although the relatively large or variable-length frames used in frame relay networks can be more efficient in terms of overhead and bandwidth than the fixed-length cells used in ATM networks, other transmission difficulties arise in frame relay networks. For example, if one virtual circuit of the frame relay network is engaged in transporting relatively large frames, other virtual circuits carrying smaller frames may suffer. In this regard it is not uncommon for two sources, one transmitting large frames and the other transmitting smaller frames, to be transported over the same POTS subscriber line. As a larger frame is being transported over the line, a smaller frame may have to wait a relatively long period of time before also being transmitted. This waiting period increases the time interval necessary to transmit the frame from a sender to a receiver through the network, such time interval being known as the “latency” of the network. If both sources are transmitting latency-insensitive traffic, e.g., data, this situation may not be a problem. However, if the smaller source is transmitting time-sensitive multimedia traffic (e.g., especially voice), excessive latency can seriously degrade the quality of service provided by the network. For networks carrying voice traffic, it is generally desirable to prevent the latency characterizing the network from exceeding 100 ms.

In addition to the sensitivity of voice transmission to network latency, variations in the transmission delay through the network experienced by different voice packets (i.e., “jitter”) can degrade overall voice quality. In order to minimize such degradation, jitter buffers may be placed within the transmission equipment at each end of a network's xDSL links. Jitter buffers operate by buffering the number of received voice packets necessary to ensure that the buffer does not become empty once the packets corresponding to a particular word or sound are begun to be read from the buffer. This tends to mitigate the effects of variations in transmission delay through the network, since the buffered packets are dispensed at a relatively constant rate. Unfortunately, the act of buffering inherently adds additional latency to the applicable transmission path, which may undesirably degrade the quality of voice and other multimedia communications.

Accordingly, it would be desirable to provide a technique for minimizing the latency and jitter exhibited by frame-based communication systems.

### SUMMARY OF THE INVENTION

In summary, the present invention pertains to a method of transferring data through a network by adaptively fragmenting frames of information into subframes. The method contemplates receiving first and second frames of information at a first node of the network. The first frame is segmented into a fragmented frame comprised of at least a first subframe and a second subframe, and the first subframe is transmitted to a second node of the network. Following transmission of the first subframe to the second node, the second frame is transmitted to the second node and the second subframe is also subsequently transmitted to the second node. A first identifying field is appended to the first subframe and a second identifying field is appended to the second subframe, the first and second identifying fields respectively indicating the relative positions of the first subframe and the second subframe within the fragmented frame.

In another aspect, the present invention comprises a data transfer device having a first input queue and a second input queue. The first input queue is disposed to accept a first frame of information and the second input queue is disposed to accept a second frame of information. The data transfer device further includes an adaptive fragmentation unit operative to (i) suspend transmission of the first frame from the first input queue upon acceptance of the second frame in the second input queue; (ii) transmit the second frame from the second input queue; and (iii) continue transmission of the first frame from the first input queue upon completion of transmission of the second frame from the second input queue.

The present invention also relates to a method for transferring data through a network having a plurality of subscriber nodes operatively connected to a network node. In accordance with this method, a first low-priority frame is accepted at a first subscriber node and transmission of the first low-priority frame to the network node is initiated. Such transmission is suspended upon acceptance of a first high-priority frame at the first subscriber node and its transmission from the first subscriber node to the network node. The method further contemplates accepting a second low-priority frame at the network node and initiating transmission of the second low-priority frame to the first subscriber node. Transmission of the second low-priority frame is suspended upon acceptance of a second high-priority frame at the network node. This suspension permits the second high-priority frame to then be transmitted from the network node to the first subscriber node.

### BRIEF DESCRIPTION OF THE DRAWINGS

For a better understanding of the nature of the features of the invention, reference should be made to the following detailed description taken in conjunction with the accompanying drawings, in which:

FIG. 1 is a block diagram of a telecommunications system within which may be practiced the adaptive frame fragmentation technique of the present invention.

FIG. 2 illustratively represents an exemplary configuration of equipment utilized by a network access point (NAP) configured in accordance with the present invention.

FIG. 3 provides an illustrative representation of a DSL concentrator as implemented in a NAP in accordance with the present invention.

FIG. 4 depicts the structure of a fragmentation buffer disposed within a frame processing module of a DSL concentrator.

FIG. 5 illustrates a typical manner in which an xDSL integrated access device (IAD) may be configured within a subscriber location in accordance with the present invention.

FIG. 6 is a block diagram illustratively representing the functional components of the IAD of FIG. 5.

FIG. 7 schematically illustrates the manner in which a High Level Data Link Control (HDLC) communications frame may be fragmented in accordance with the present invention during transmission from a fragmentation buffer of a frame processing module.

FIG. 8 depicts an exemplary template fragmentation header for subframes created during segmentation of a generic HDLC data frame.

FIG. 9 shows an exemplary template fragmentation trailer for subframes created during segmentation of a generic HDLC data frame.

FIG. 10 is a flowchart illustrating a process for selectively segmenting data frames from lower-priority buffer queues so as to minimize the latency and jitter associated with transmission of voice frames from higher-priority queues.

FIG. 11 illustrates by way of flowchart a TransmitFragment routine referenced in FIG. 10.

FIG. 12 is a flowchart illustrating an alternately preferred implementation of the TransmitFragment routine referenced in FIG. 10.

FIG. 13 is a flowchart illustrating a process for receiving subframes collectively corresponding to frames previously adaptively fragmented in accordance with the present invention.

### DETAILED DESCRIPTION OF THE INVENTION

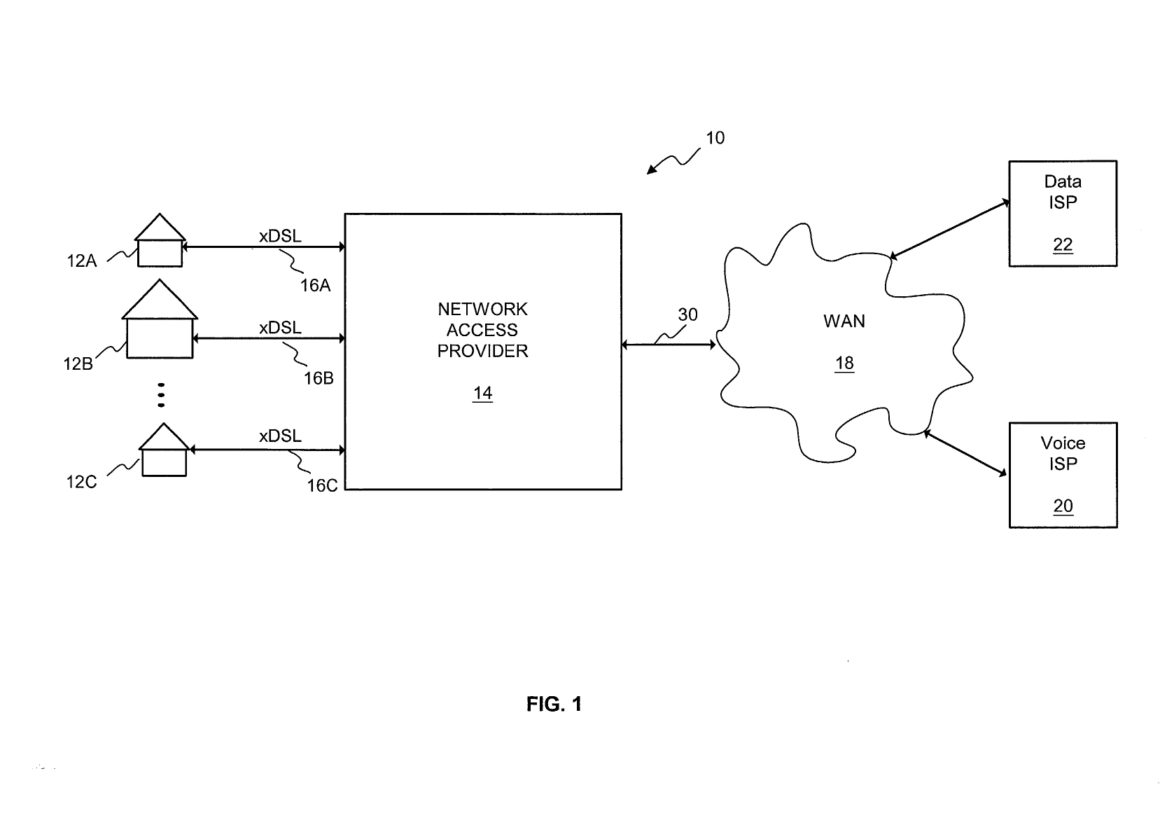

FIG. 1 is a block diagram of a telecommunications system 10 to which general reference will be made in describing the adaptive frame fragmentation technique of the present invention. As shown, a plurality of subscriber locations 12 are connected to a network access provider (NAP) 14 over a corresponding plurality of xDSL links 16. The NAP 14, via a wide area network (WAN) 18, is in communication with an Internet service provider handling voice traffic (Voice ISP 20) and an Internet service provider handling data traffic (Data ISP 22). The WAN 18 may be implemented as, for example, an ATM network, a frame relay network, or an Internet Protocol (IP) network.

NAP 14 represents an entity that (i) terminates xDSL link 16 at a central office or other local exchange termination point, and (ii) provides access to higher-level voice and data services respectively offered by the Voice ISP 20 and the Data ISP 22. It should be understood that NAP 14, Voice ISP 20 and Data ISP 22 may or may not be affiliated or under common control. For example, a regional Bell operating company (RBOC) could provide both xDSL service and data-based Internet access, in which case it would maintain the role of both NAP 14 and Data ISP 22. In operation, the NAP 14 receives frames of voice and data information from the xDSL links 16. The NAP 14 forwards information from the received frames to the WAN 18, which delivers such information as appropriate to the Voice ISP 20 or the Data ISP 22. It should be clear that data transfer occurs in the reverse direction from the Voice ISP 20 and Data ISP 22 via the WAN 18 and the NAP 14. In this way the system 10 transports frames of voice and data information between the subscriber locations 12 and the Voice ISP 20 and Data ISP 22.

Each subscriber location 12 includes customer premises equipment (not shown) capable of effecting voice and/or data communication over its xDSL link 16. For example, such equipment may comprise an xDSL interface for transferring frames of voice information to and from one or more voice-based communication instruments (e.g., telephones), and/or for providing frames of data to a data subsystem (e.g., a personal computer, computer workstation or other computing device). In a preferred implementation each xDSL link 16 supports frame-based communication (e.g., frame relay) between a subscriber location 12 and the network access provider 14.

As was mentioned above, the use of large or variable-length framed packets can increase the latency and jitter characterizing the transmission of voice information. In the system of FIG. 1, the transport of large frames of data information to and from a subscriber location 12 over its associated xDSL link 16 can delay the transmission of frames of voice information over such link. For example, if an xDSL link 16 is running at 320 kilobits per second (Kbps) and a 1600 byte data frame is sent from the associated subscriber location 12, then voice traffic on the link 16 could be delayed for up to 40 milliseconds. Such delay would likely cause an unacceptable degree of jitter in the voice traffic at the receiving end. As is described hereinafter, the present invention overcomes these difficulties by adaptively fragmenting frames of lower priority (e.g., data frames) into smaller subframes for transmission over an xDSL link 16 in order to minimize the time spent by frames of higher priority (e.g., frames of video or voice) queuing for transmission over the link 16. Although the following detailed description of the invention is presented in a context in which frames of voice information (“voice frames”) constitute the high-priority traffic of interest, the present invention is equally applicable to embodiments in which other high-priority traffic (e.g., video) is to be transported with low latency and jitter.

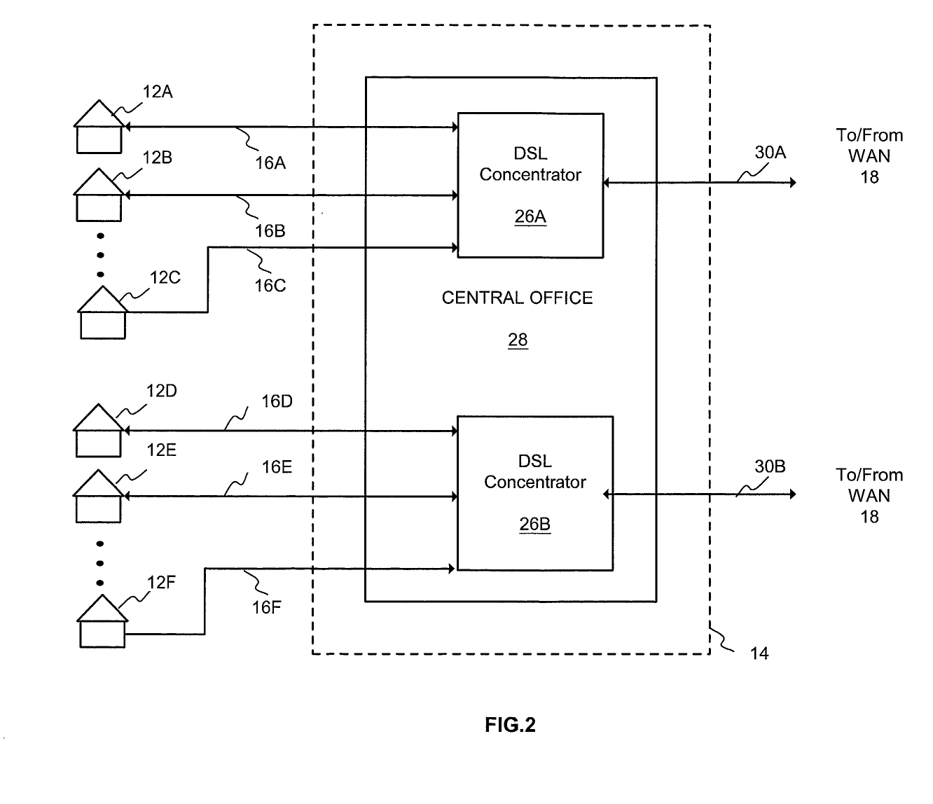

FIG. 2 illustratively represents an exemplary configuration of equipment utilized by the NAP 14. As shown, the NAP 14 utilizes one or more DSL concentrators 26 located at a central office 28 or other facility positioned near enough subscriber locations 12 to enable xDSL transmission to be effected over xDSL links 16. Each DSL concentrator 26 is designed to support high-bandwidth applications over existing subscriber lines (i.e., the xDSL links 16). In operation, each DSL concentrator 26 performs adaptation between the xDSL links 16 and the WAN 18. In the downstream direction (i.e., towards the subscriber locations 12), each DSL concentrator 26 may perform routing and demultiplexing of framed data information or ATM cells received from the WAN 18 over high-speed line 30. In the upstream direction (i.e., towards the WAN 18), each DSL concentrator 26 may perform multiplexing and concentration of framed data information received over the xDSL links 16 for transmission on high-speed line 30. Each DSL concentrator 26 may be implemented using, for example, a CopperEdge® 200 DSL Concentrator available from Copper Mountain Networks, Inc. of Palo Alto, Calif.

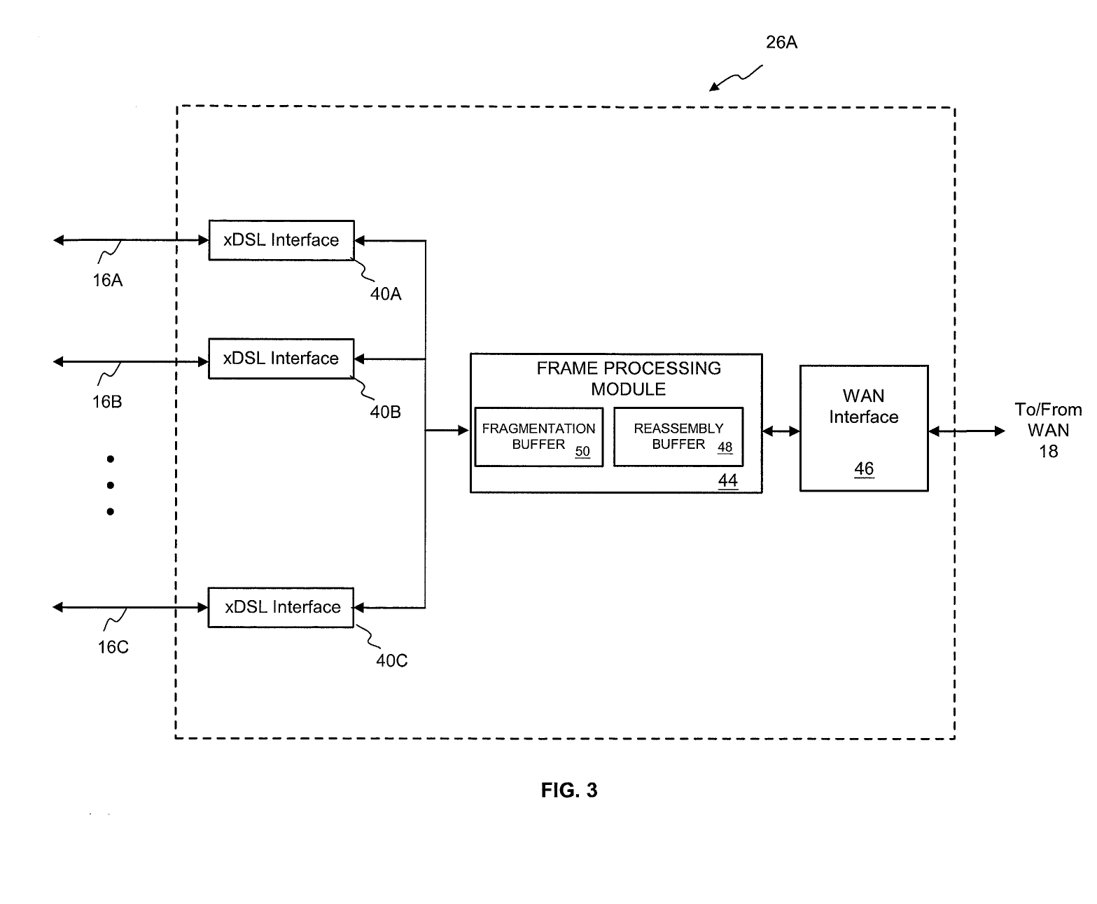

FIG. 3 provides a more detailed representation of the DSL concentrator 26A as configured to effect adaptive frame fragmentation in accordance with the present invention. The DSL concentrator 26A includes several xDSL interfaces 40, each of which defines a port for receiving an xDSL link 16. Each xDSL interface 40 provides an endpoint for the xDSL physical layer between the DSL concentrator 26A and an associated subscriber location 12, and manages this physical layer by performing xDSL modulation/demodulation in accordance with any one of several formats known to those skilled in the art. The xDSL physical layer provides a point-to-point physical layer bitstream upon which any of various framed-packet data formats can be carried in the data link layer. Each xDSL interface 40 is connected to a frame processing module 44, which in turn is connected to a WAN interface 46. The frame processing module 44 manages the data link layer in connection with the transport of framed data information across the xDSL links 16. As shown, the frame processing module 44 includes a re-assembly buffer 48 and a fragmentation buffer 50 respectively used in connection with re-assembly and fragmentation of framed data information in accordance with the present invention.

The WAN 18 will typically comprise a conventional wide area network operative in accordance with either the frame relay, ATM or IP protocols. When the WAN 18 is implemented as an ATM network, the WAN interface 46 performs the upstream and downstream routing of ATM cell traffic on, for example, a virtual channel identifier basis to and from the Voice ISP 20 and Data ISP 22. In this context the WAN interface 46 will typically (i) interface with ATM network elements such as ATM switches, ATM concentrators, and/or ATM routers, and (ii) establish and configure virtual circuits (VCs) in accordance with standard ATM traffic parameters. Establishment of such VCs enables the WAN interface 46 to map prioritized voice paths carried over the xDSL links 16 to real-time VCs on an ATM-based WAN 18. When the WAN 18 is implemented as a frame relay or IP network, the WAN interface 46 may be similarly configured to manage the communication with the Voice ISP 20 and Data ISP 22 via framed data information.

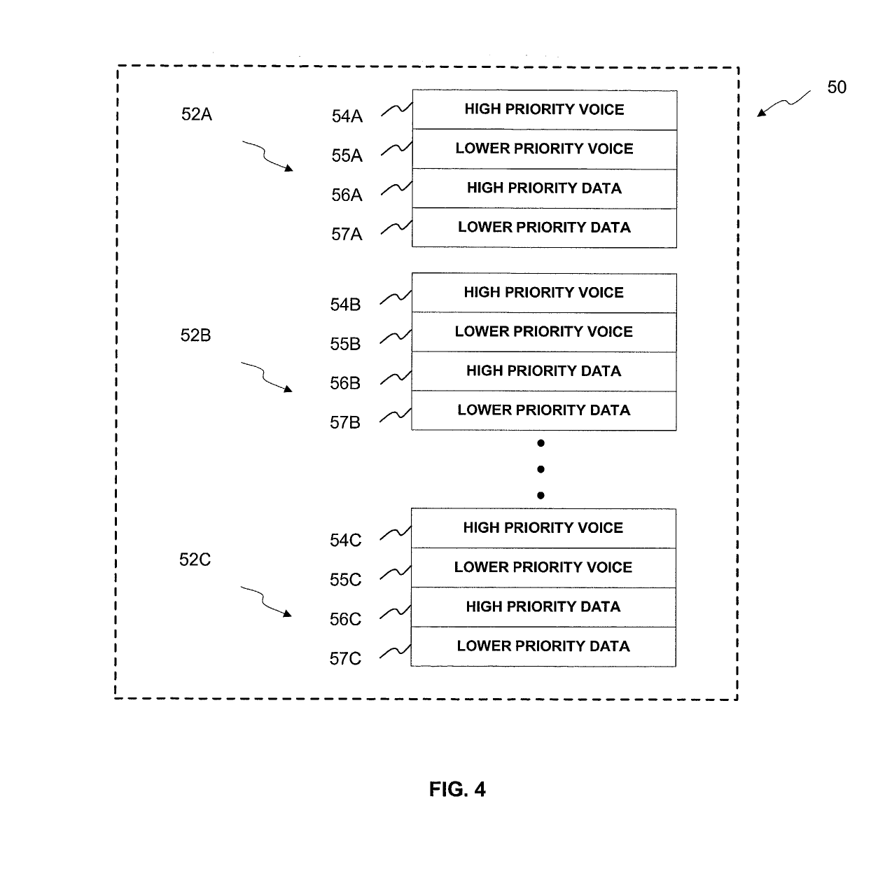

FIG. 4 depicts the structure of the fragmentation buffer 50 disposed within the frame processing module 44. As shown, the fragmentation buffer 50 includes a plurality of line buffers 52 respectively corresponding to the plurality of xDSL interfaces 40. That is, each line buffer 52 contains the frames of voice and data information received from the WAN 18 to be transmitted by a respective one of the xDSL interfaces 40 over its associated xDSL link 16. Each line buffer 52 is comprised of a set of four priority queues 54-57 into which frames of information are inserted upon receipt from the WAN interface 46. Although each line buffer 52 is described herein as being structured to include a set of four priority queues, those skilled in the art will appreciate that line buffers having differing numbers of priority levels are within the scope of the present invention. In a preferred implementation the first priority queue 54 and the second priority queue 55 of each line buffer 52 receive frames exclusively from the Voice ISP 20, while the third priority queue 56 and the fourth priority queue 57 receive frames exclusively from the Data ISP 22. The priority queues 54-57 are arranged in order of decreasing priority. That is, the first priority queue 54 and the second priority queue 55 are reserved for voice traffic transported at higher service levels than the data traffic occupying the third priority queue 56 and the fourth priority queues 57. More specifically, the frames of voice information accorded the highest service level are placed in the first priority queue 54, while voice frames of lower priority are inserted into the second priority queue 55. Similarly, the frames of data information accorded the highest data service level are placed in the third priority queue 56, while data frames of lower priority are inserted into the fourth priority queue 57.

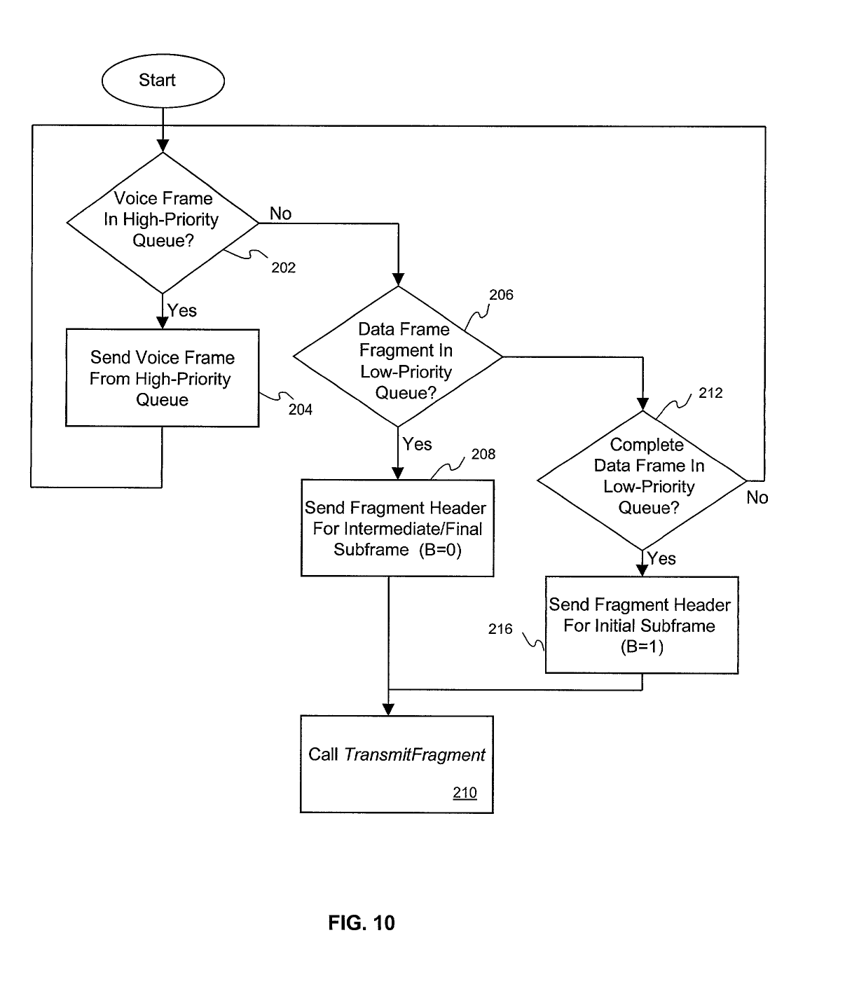

In accordance with the present invention and as is further described below with reference to FIGS. 10-12, data frames are transmitted from either the third priority queue 56 or the fourth priority queue 57 until such time as a first voice frame becomes present within the first priority queue 54 and/or second priority queue 55. At such time transmission of the instant data frame from the third priority queue 56 or the fourth priority queue 57, as applicable, is suspended. In the event transmission of the data frame is suspended, an identifying field in the form of a trailer is appended to the end of an initial subframe of the data frame (i.e., to the portion of the data frame transmitted prior to the arrival of the voice frame within the first priority queue 54 or second priority queue 55). The first voice frame is then completely transmitted from either the first priority queue 54 or the second priority queue 55, and transmission of the data frame is resumed from either the third priority queue 56 or the fourth priority queue 57. Transmission of such data frame continues until the earlier of either the (i) complete transmission of such data frame, or (ii) the arrival of a second voice frame in either the first priority queue 54 or the second priority queue 55. In the latter case the transmission of the data frame is again suspended, and an identifying field in the form of a trailer is appended to the most recently transmitted subframe of such data frame. Processing of the second voice frame and the remaining portion of the data frame then continues as described above. That is, the second voice frame is transmitted in its entirety and transmission of the data frame is subsequently reinitiated. This approach advantageously minimizes the latency and jitter characterizing voice transmission through the system 10, since framed voice data is not queued for substantial periods pending transmission of lower priority data traffic.

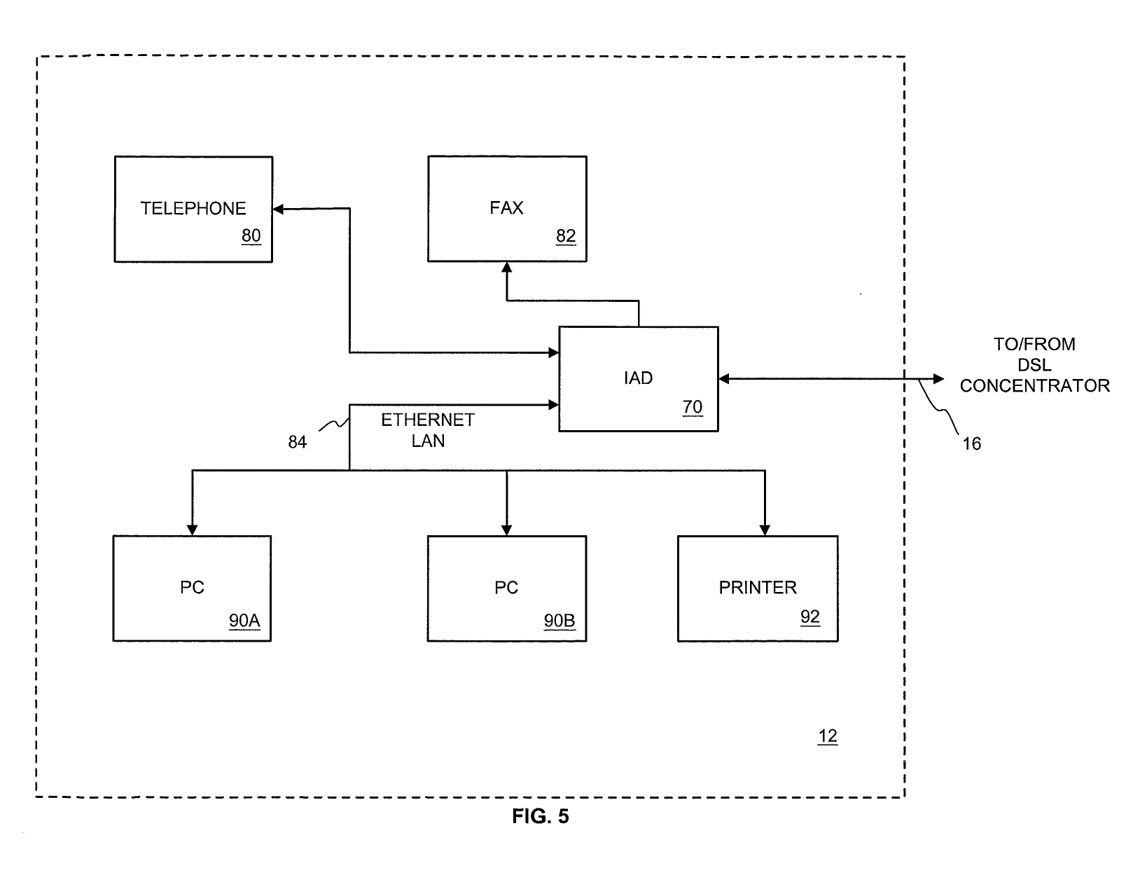

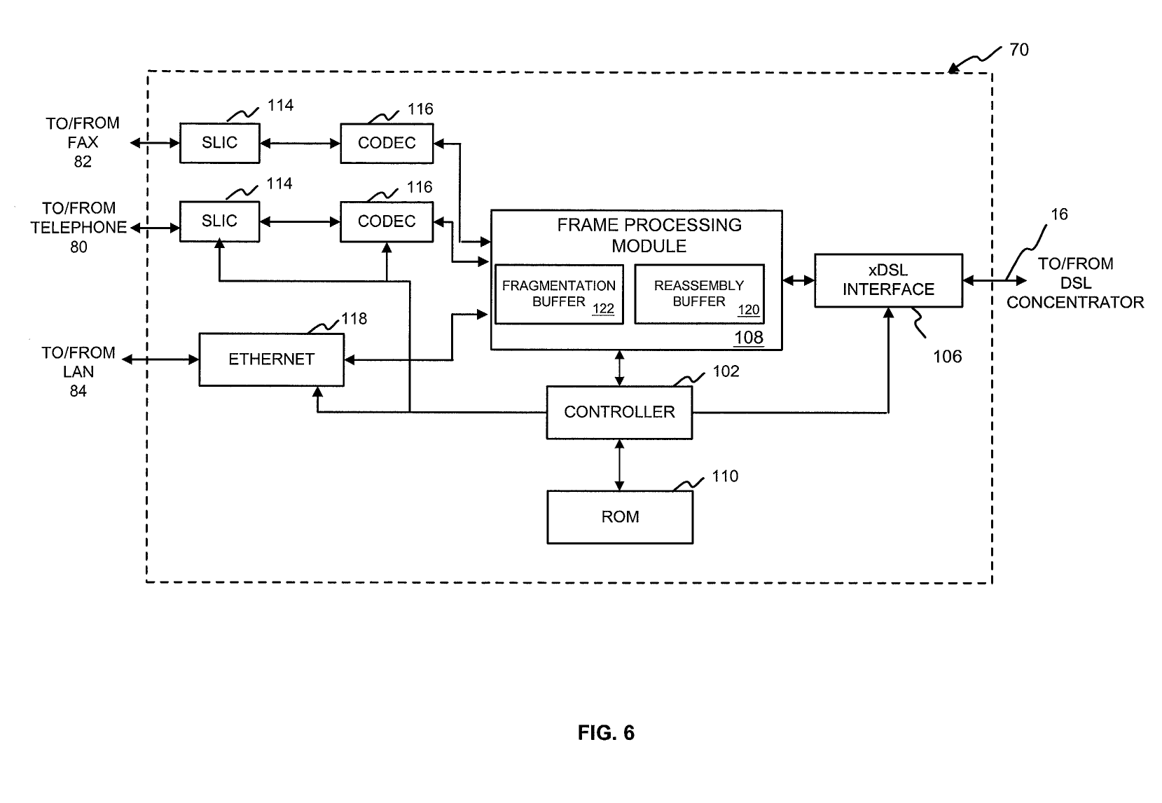

FIG. 5 illustrates a typical manner in which an xDSL integrated access device (IAD) 70 may be configured within a subscriber location 12. The IAD 70 facilitates voice and data communication between one or more users at a subscriber location 12 and the Voice ISP 20 and the Data ISP 22. As shown, the IAD 70 interfaces with telephone devices such as a telephone 80 and fax machine 82, as well as with an Ethernet local area network (LAN) 84. The subscriber location 12 may also include computers 90A, 90B and a laser printer 92 connected to the Ethernet LAN 84. In operation, the LAD 70 receives voice and data traffic from the telephone 80, fax machine 82 and Ethernet LAN 84, and prioritizes it for transmission to a DSL concentrator 26 over the xDSL link 16 in the manner described below with reference to FIG. 6. In the reverse direction, information framed in the appropriate format is received from the DSL concentrator 26 over xDSL link 16 and routed to the applicable telephone device 80, 82 or to the Ethernet LAN 84. The IAD 70 may be implemented using, for example, a CopperRocket® 408 SDSL Integrated Access Device available from Copper Mountain Networks, Inc. of Palo Alto, Calif.

FIG. 6 is a block diagram illustratively representing the functional components of the IAD 70. Specifically, in an exemplary implementation the IAD 70 comprises a controller 102, an xDSL interface 106, a frame processing module 108 for buffering voice and data frames, a read only memory (ROM) 110 that stores a software program executed by the controller 102, and one or more subscriber line interface circuits (SLICs) 114 and associated coder/decoders (CODECs) 116. The IAD 70 further includes an Ethernet interface 118 comprised of a standard network interface circuit device for interfacing digital data to and from the Ethernet LAN 84.

Referring to FIG. 6, the xDSL interface 106 connects directly to an xDSL link 16 and performs the xDSL modulation and demodulation necessary to transport information via the xDSL line 16 to a DSL concentrator 26. In addition, the xDSL interface 106 formats the modulated information into a suitable framed packet format utilized by the WAN 18 for the transport of information. As shown, the controller 102 is connected to the DSL interface 106, the frame processing module 108, ROM 110, each of the CODECS 116, and to the Ethernet interface 118. The controller 102 is also connected to each of the SLICs 114 to enable the controller 102 to detect when a telephone device goes off-hook and to command the applicable SLIC 114 to ring such device. Each SLIC 114 is connected to a telephone device or, alternately, to a private branch exchange (PBX) or the like by a standard analog telephone line. In operation, each SLIC 114 provides the precise voltages and currents required to interface to telephone devices. Each CODEC 116 is a coder/decoder that converts analog telephone signals (voice and other in-band telephone signals) to digital bit streams, and converts digital bit streams to analog telephone signals.

The frame processing module 108 is substantially similar to the frame processing module 44 (FIG. 3). In particular, the frame processing module 108 includes a re-assembly buffer 120 and a fragmentation buffer 122 respectively used in connection with re-assembly and fragmentation of framed data information. Since the fragmentation buffer 122 provides framed data information to only a single xDSL interface 106, it may be realized through only a single line buffer comprised of a set of four priority queues. In operation, the frame processing module 108 and xDSL interface 106 collectively manage communication of framed data information across the xDSL link 16 in the manner described above with reference to FIG. 3. That is, the fragmentation buffer 122 contains the framed voice and data information received from the Ethernet LAN 84 and telephone devices 80, 82 to be transmitted by the xDSL interface 106 over its associated xDSL link 16. Specifically, frames of data information received from the Ethernet LAN 84 and fax device 82 will typically be placed in one of the two lowest-priority queues of the fragmentation buffer 122, while higher-priority frames of voice information received from the telephone device 80 will generally be inserted into one of the two highest priority queues. Transmission of framed voice and data information from the four priority queues of the fragmentation buffer then proceeds as described above with reference to FIG. 4.

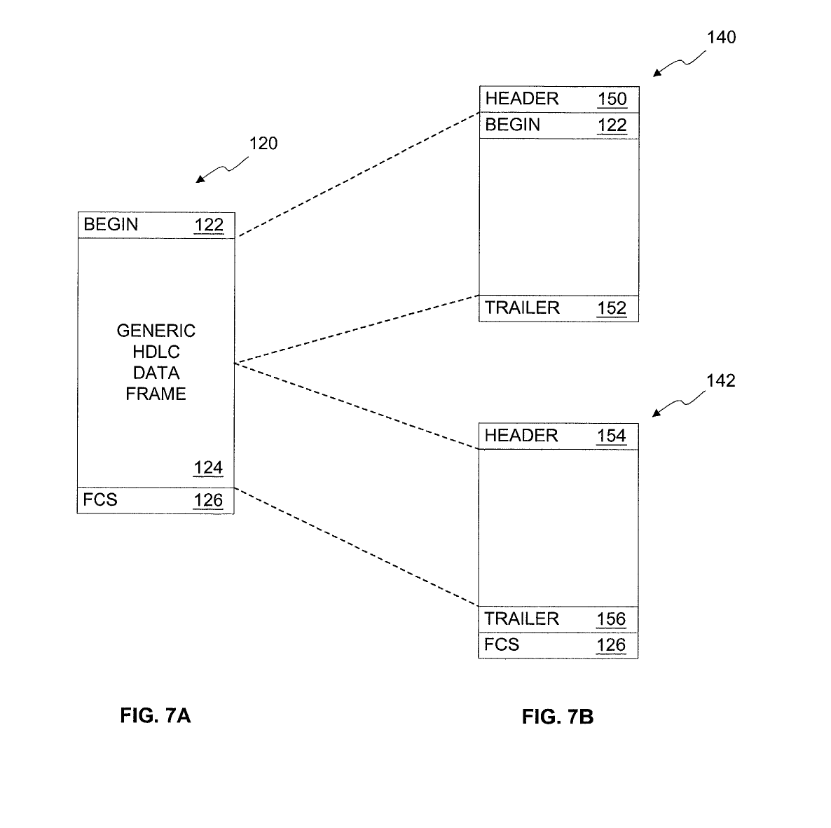

With reference now to FIG. 7, shown is a schematic view illustrating a standard High Level Data Link Control (HDLC) communications frame 120 disposed to be operated upon by frame processing module 44 of FIG. 3. As shown, HDLC communications frame 120 includes a begin flag 122 signaling the start of the frame and payload comprised of a data frame 124. The data frame 124 may comprise a generic HDLC data frame and in an exemplary implementation of the system 10 is typically less than 1600 bytes in length; however, data frame 124 can be any number of bytes in length. Following generic HDLC data frame 124 is frame check sequence (FCS) frame 126. The FCS frame 126 is typically either 2 or 4 bytes in length and generally comprises a cyclical redundancy check (CRC) error detection code used to ensure the integrity of the transported information. In the exemplary implementation the HDLC communication frames 120 used in communication to and from telephone devices (e.g., telephone 80 and fax 82) are formatted in accordance with the Q.922 frame relay protocol as further defined in Internet Engineering Task Force (IETF) Request for Comment (RFC)-1490. Similarly, the HDLC communication frames 120 operated upon by the frame processing module 44 in connection with communication to and from the Ethernet LAN 84 are preferably formatted in accordance with the Q.922 frame relay protocol as further defined in Internet Engineering Task Force (IETF) Request for Comment (RFC)-1483.

FIG. 7 schematically illustrates the manner in which an HDLC communications frame 120 may be fragmented in accordance with the present invention during transmission from fragmentation buffer 122, it being understood that a substantially identical fragmentation process is employed within fragmentation buffer 50. For exemplary purposes, it is assumed that the HDLC communications frame 120 has been placed in either the third priority queue 56 or the fourth priority queue 57 of a line buffer 52 within the fragmentation queue, and undergoes fragmentation in response to the arrival at a time T1 of another HDLC communications frame 120 within a higher priority queue of the line buffer 52. Upon such arrival, HDLC communications frame 120 is segmented into a first subframe 140 and a second subframe 142. The first subframe 140 is filled with raw data from generic HDLC data frame 124 transmitted prior to time T1, while the second subframe 142 contains the remainder of the raw data from generic HDLC data frame 124. For purposes of explanation it is assumed that no additional HDLC communication frames of higher priority arrive during transmission of the second subframe 142, it thus being unnecessary to segment the second subframe 142 into third and fourth subframes.

Referring to FIG. 7, the first subframe 140 includes identifying fields in the form of a first fragmentation header 150 and a first fragmentation trailer 152. Similarly, the second subframe 142 includes identifying fields in the form of a second fragmentation header 154 and a second fragmentation trailer 156. The first subframe 140 further includes the begin flag 122, while the second subframe 142 contains the FCS frame 126. The first fragmentation header 150 preferably includes a field indicating that the first subframe 140 is the initial subframe in the sequence of two or more subframes created by segmenting generic HDLC data frame 124. In addition, the second fragmentation trailer 156 preferably includes a field defining the second subframe 142 as being the final subframe in the sequence.

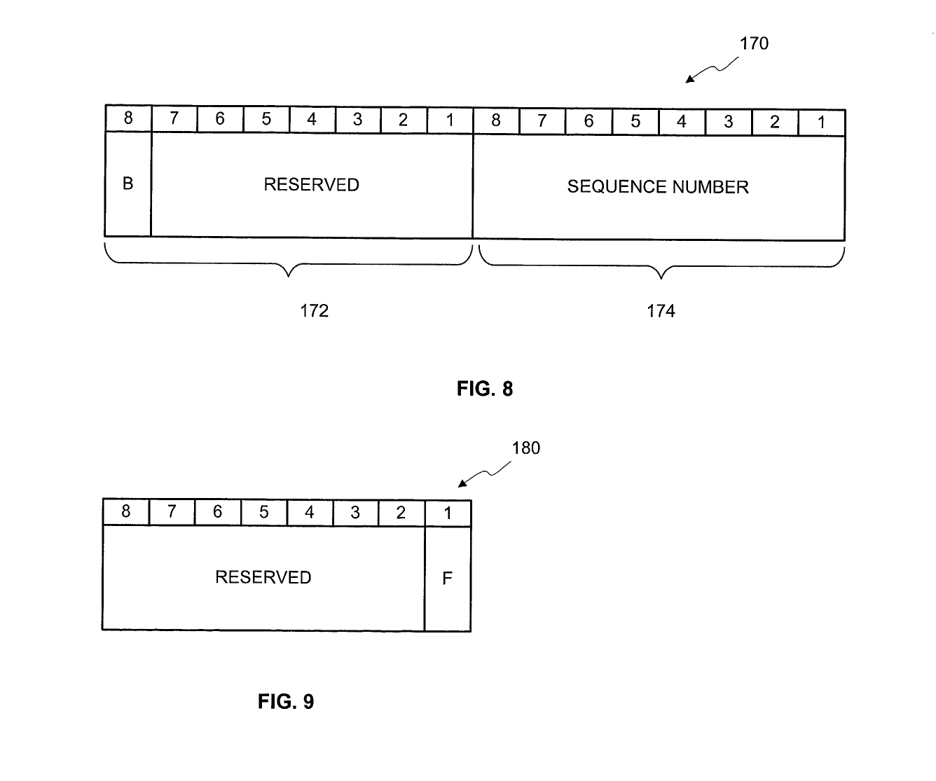

FIG. 8 depicts an exemplary template fragmentation header 170 for subframes created during segmentation of a generic HDLC data frame 124, such as the first subframe 140 and the second subframe 142. The template fragmentation header 170 is comprised of a first octet 172 and a second octet 174. The most significant bit (i.e., bit 8) of the first octet 172 defines a parameter “B”, which when set to “1” indicates that the associated subframe is the initial subframe in a subframe sequence corresponding to a segmented generic HDLC data frame 124. The parameter “B” is set to “0” for all other subframes in the subframe sequence. In a preferred embodiment the seven least significant bits of the first octet 172 are reserved and accorded values as necessary to ensure all fragment headers are distinguished from any other framing headers and/or flags which may be introduced during processing of a generic HDLC data frame 124. The bits of the second octet 174 are used to identify the position of the associated subframe within the subframe sequence of the segmented generic HDLC data frame 124.

Turning now to FIG. 9, shown is an exemplary template fragmentation trailer 180 for subframes created during segmentation of a generic HDLC data frame 124. As shown, the template fragmentation header 180 is comprised of a single octet. The least significant bit of this octet defines a parameter “F”, which when set to “1” indicates that the associated subframe is the final subframe in the sequence of subframes created during segmentation of a generic HDLC data frame 124. The seven most significant bits of template fragmentation trailer 180 are reserved and accorded values as necessary to ensure all fragment trailers are distinguished from all fragment headers and from any other framing headers and/or flags which may be introduced during processing of a generic HDLC data frame 124.

In summary, the fragment header of the first subframe in a subframe sequence created during segmentation of a generic HDLS data frame will preferably define the parameter “B” as “1” and the parameter “F” as “0”. The fragment header of intermediate subframes within the subframe sequence will define the parameter “B” as “0” and the parameter “F” as “0”. Finally, the fragment header of the final subframe within the subframe sequence will define the parameter “B” as “0” and the parameter “F” as “1”. In addition, the second octet of each fragment header will identify the position of the subframe within the subframe sequence. In an alternate implementation, a fragment header and fragment trailer is appended even to those generic HDLS data frames 124 transmitted without undergoing segmentation. In this case both the parameter “B” in the fragment header and the parameter “F” in the fragment trailer are set to “1”, thereby distinguishing such a complete HDLS data frame 124 from any subframes arising from segmentation of any other generic HDLS data frame 124.

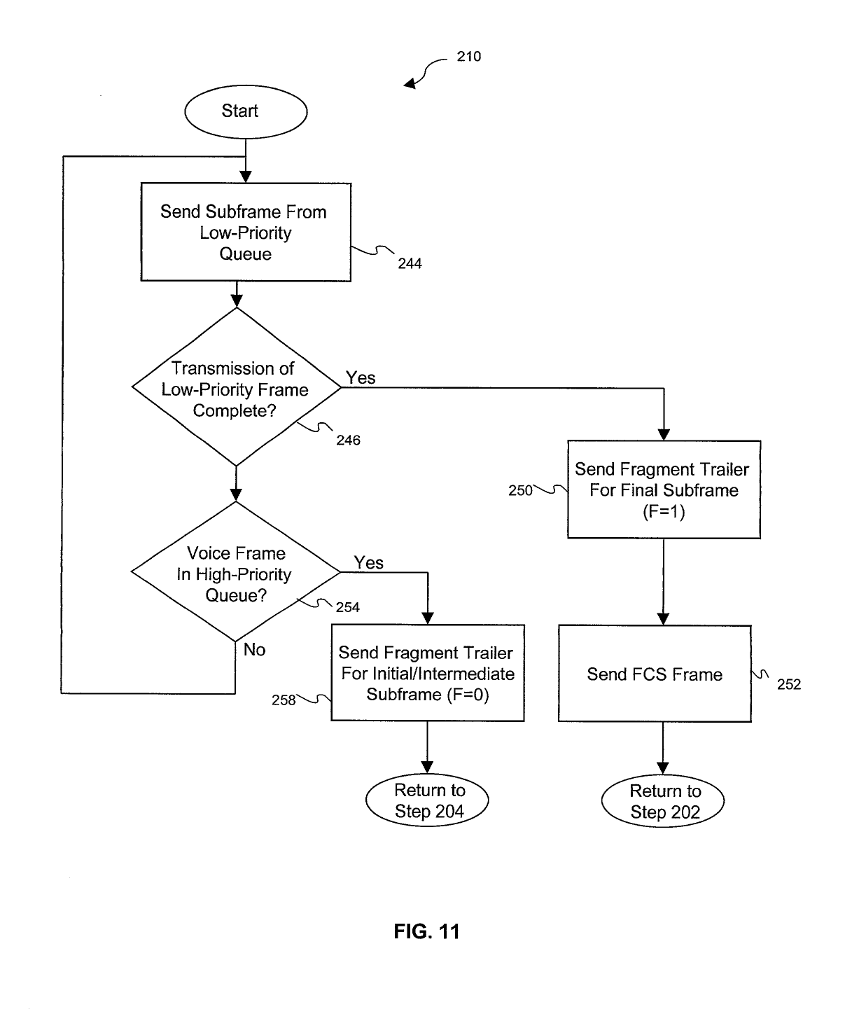

Referring now to FIG. 10, shown by way of flowchart is a process for selectively segmenting data frames from lower-priority buffer queues into sequences of subframes so as to minimize the latency and jitter associated with transmission of voice frames from higher-priority queues. The process is initiated by determining whether a voice frame is present within either of the higher-priority queues (i.e., in either the first priority queue and/or the second priority queue) of the applicable line buffer (step 202). If one or more voice frames are present in one of the higher-priority queues, each such voice frame is transmitted (step 204). Otherwise, it is determined whether any remaining fragments of partially transmitted data frames are present in either of the lower-priority queues (i.e., in either the third priority queue and/or the fourth priority queue) of the applicable line buffer (step 206). If such a fragment is present, a fragment header for an intermediate/final subframe is transmitted (i.e., B=0) in a step 208. Transmission of the remaining subframes of the fragment is then initiated in accordance with a called TransmitFragment routine (step 210) described below with reference to FIG. 11. If no such fragment is present, then it is determined whether any complete data frames are present in either of the lower-priority queues (step 212). If no such complete data frames are present within either of the lower-priority queues, processing returns to step 202. If such a complete data frame is present within at least one of the lower-priority queues, then a fragment header for an initial subframe is transmitted (i.e., B=1) in a step 216 and the TransmitFragment routine is called (step 210).

FIG. 11 illustrates by way of flowchart the TransmitFragment routine referenced in FIG. 10. As shown, the routine is commenced by transmitting a subframe of a predetermined size related to the line speed of the applicable xDSL link 16 from the applicable low-priority queue (step 244). If transmission of such subframe completes transmission of the data frame from the applicable low-priority queue (step 246), then a fragment trailer for a final subframe (i.e., F=1) is transmitted in step 250. Processing then returns to step 202 (FIG. 10) following transmission of the FCS frame for the completely transmitted low-priority data frame (step 252). If, on the other hand, transmission of the data frame from the applicable low-priority queue has not been completed, then it is determined whether a voice frame is present within either of the higher-priority queues of the applicable line buffer (step 254). If such a voice frame is so present, then a fragment trailer for a first/intermediate subframe (i.e., F=0) is transmitted in a step 258 and processing is returned to step 204 (FIG. 10). In the absence of such a voice frame, processing is returned to step 244.

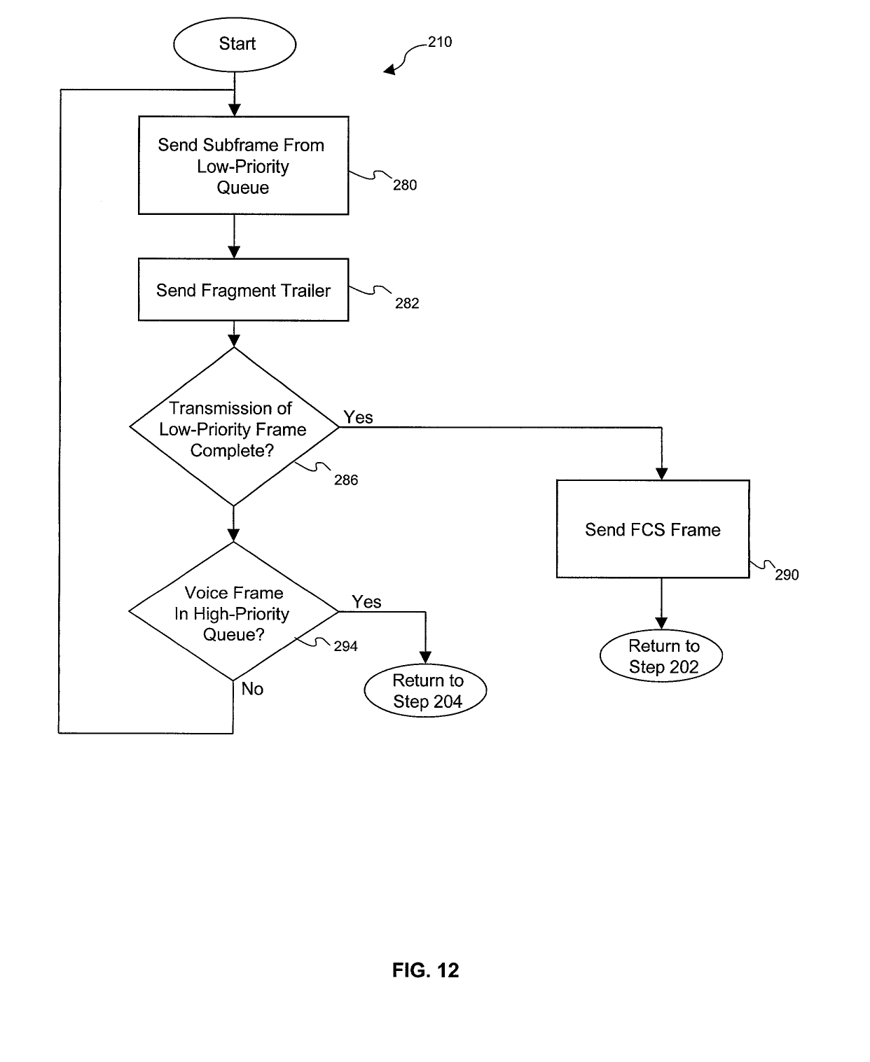

FIG. 12 is a flowchart illustrating an alternately preferred implementation of the TransmitFragment routine referenced in FIG. 10. In contrast to the approach illustrated in FIG. 11, the implementation of the TransmitFragment routine of FIG. 12 contemplates the appending of a fragment header and a fragment trailer to each subframe transmitted from the applicable low-priority queue. As shown, transmitting a subframe of a predetermined size from the applicable low-priority queue (step 280) commences the routine of FIG. 12. A fragment trailer for a final subframe (i.e., F=1) is then transmitted (step 282). If transmission of such subframe completes transmission of the data frame from the applicable low-priority queue (step 286), then processing is returned to step 202 (FIG. 10) following transmission of the FCS frame for the now completely transmitted low-priority data frame (step 290). If, on the other hand, transmission of the data frame from the applicable low-priority queue has not been completed, then it is determined whether a voice frame is present within either of the higher-priority queues of the applicable line buffer (step 294). If such a voice frame is so present, processing is returned to step 204 (FIG. 10). In the absence of such a voice frame, then a fragment header for an intermediate/final fragment is transmitted (i.e., B=0) in a step 298 and processing is returned to step 280.

As should be apparent from the foregoing discussion, the adaptive frame fragmentation techniques of the present invention may be utilized to minimize the latency and jitter characterizing frame-based voice communications and other time-sensitive applications. To this end the present invention contemplates transmission of low-priority data frames as sequences of subframes. In this way the maximum delay experienced by high-priority frames as a consequence of transmission of preceding lower-priority frames is limited to the time required to transmit one such subframe across the applicable xDSL link. In order to maintain this delay within acceptable limits, the byte size of each subframe is set as a function of the line speed of the applicable xDSL line. Clearly, the utilization of higher line speeds permits the size of each subframe to be increased without causing such delay to exceed acceptable limits. TABLE I below lists a set of exemplary subframe sizes as a function of the line speed of the applicable xDSL link.

| Line Speed (Kbps) | Subframe Size (bytes) |
|---|---|
| less than 160 | 128 |
| 320-416 | 258 |
| 784 | 512 |

As is evidenced by FIGS. 10-12, the adaptive frame fragmentation technique of the present invention provides frame-based communication systems with the flexibility to exhibit the favorable latency and jitter characteristics typically associated with packet-based systems. By inappreciably decreasing the efficiency of frame-based communication through the selective transmission of sequences of subframes, the present invention prevents relatively lengthy frames from significantly degrading the latency and jitter of frame-based communication systems. That is, the adaptive frame fragmentation technique of the present invention counterintuitively introduces an inefficiency into frame-based communication structures which enables the rapid transition to an operative mode akin to that of packet-based systems.

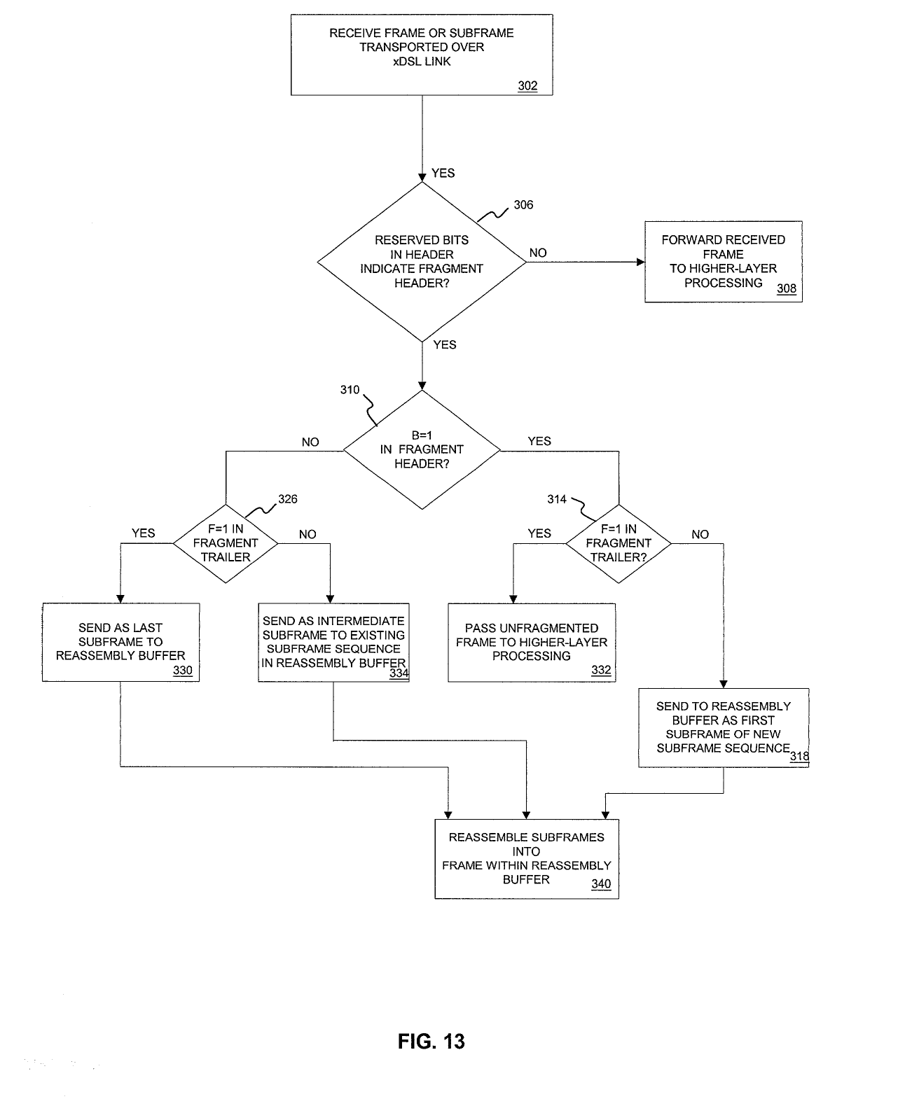

Turning now to FIG. 13, shown by way of flowchart is a process for receiving subframes collectively corresponding to data frames that have been adaptively fragmented in accordance with the present invention. Upon receiving a subframe or frame transported over an xDSL link 16 (step 302), the frame processing module 44, 108 examines the reserved bits within the header of such subframe or frame to determine if such header is a fragment header (step 306). When such header is determined to correspond to a complete data frame (i.e., is not a fragment header), the received data frame is forwarded for processing in accordance with higher-layer protocols (step 308). If a fragment header is instead detected in step 306, then it is determined whether the parameter “B” has been set to “1” (i.e., B=1) within such fragment header (step 310). If so, then it is next determined whether the parameter “F” has been set to “1” (i.e., F=1) within the fragment trailer for the received subframe (step 314). If the parameter “F” has not been so set, then the received subframe (B=1, F=0) corresponds to the first subframe in a subframe sequence comprising a fragmented frame. Accordingly, this first subframe is sent to the applicable re-assembly buffer 48, 120 in order to initiate assembly of such sequence (step 318). If on the other hand it is determined that F=1 (step 314), then a complete data frame has been received and it is forwarded for processing in accordance with higher-layer protocols (step 322).

Referring again to step 310, if it is determined that B=1 in the fragment header for the received subframe, then it is further determined whether F=1 in the associated fragment trailer (step 326). If it is so determined that F=1, then the received subframe is forwarded to the applicable re-assembly buffer 48, 120 as the last subframe within the subframe sequence already initiated therein (step 330). If it is instead found that F=0 in step 326, then the received subframe is forwarded to the applicable re-assembly buffer 48, 120 as an intermediate subframe to be concatenated with the one or more other subframes previously accumulated therein (step 334). Within the applicable re-assembly buffer 48, 120, each subframe within the subframe sequence corresponding to a given fragmented frame is placed in the appropriate relative position based upon the sequence information within the second octet 174 of the fragment header 170 of each such subframe (step 340). The resulting subframe sequence is then reassembled into a generic HDLC data frame or other frame-based format for processing in accordance with higher-layer protocols.

The foregoing description, for purposes of explanation, used specific nomenclature to provide a thorough understanding of the invention. However, it will be apparent to one skilled in the art that the specific details are not required in order to practice the invention. In other instances, well-known circuits and devices are shown in block diagram form in order to avoid unnecessary distraction from the underlying invention. Thus, the foregoing descriptions of specific embodiments of the present invention are presented for purposes of illustration and description. They are not intended to be exhaustive or to limit the invention to the precise forms disclosed, obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the following claims and their equivalents define the scope of the invention.

What is claimed is:

1. A method of transferring data through a network by adaptively fragmenting frames of information into subframes, the method comprising:
receiving at a first node of said network a low-priority frame;
segmenting said low-priority frame into a fragmented frame comprised of at least a first subframe and a second subframe;
receiving at said first node of said network a high-priority frame;
transmitting said high-priority frame to a second node of said network following transmission of said first subframe to said second node;
transmitting said second subframe to said second node following transmission of said high-priority frame to said second node; and
appending a first identifying field to said first subframe and a second identifying field to said second subframe, said first and second identifying fields respectively indicating the relative position of said first subframe and said second subframe within said fragmented frame.

2. The method of claim 1 wherein said first identifying field comprises a first fragment header, said first fragment header indicating said first subframe is an initial subframe of said fragmented frame.

3. The method of claim 2 wherein said second identifying field comprises a second trailer, said method further including appending a first trailer to said first subframe wherein said second trailer indicates that said second subframe is a last subframe of said fragmented frame and wherein said first trailer indicates that said first subframe precedes said last subframe in said fragmented frame.

4. The method of claim 2 further including appending a second fragment header to said second subframe, said second fragment header indicating said second subframe follows said initial subframe in said fragmented frame.

5. The method of claim 2 further including:
dividing said second subframe into a third subframe and a fourth subframe; and
appending a third fragment trailer to said third subframe, said third fragment trailer indicating that said third subframe precedes a last subframe in said fragmented frame.

6. A data transfer device comprising:
a buffer coupled to an input of said data transfer device, wherein said buffer is operable to receive a low-priority frame and high-priority frame;
an adaptive fragmentation unit operative to (i) segment said low-priority frame into a fragmented frame comprised of at least a first subframe and a second subframe, (ii) append a first identifying field to said first subframe and a second identifying field to said second subframe, said first and second identifying fields respectively indicating the relative position of said first subframe and said second subframe within said fragmented frame, (iii) transmit said high-priority frame subsequent to transmitting said first subframe, and (iv) transmit said second sub frame subsequent to transmission of said high-priority frame.

7. The data transfer device of claim 6 wherein said first identifying field comprises a first trailer and wherein said adaptive fragmentation unit is further operative to append a second trailer to said second subframe, said second trailer indicating that said second subframe is a last subframe of said fragmented frame and said first trailer indicating that said first subframe precedes said last subframe in said fragmented frame.

8. The data transfer device of claim 7 wherein said adaptive fragmentation unit is further operable to append a first header to said first subframe and a second header to said second subframe, said first header indicating said first subframe is an initial subframe of said fragmented frame and said second header indicating said second subframe follows said initial subframe in said fragmented frame.

9. The data transfer of claim 7 wherein said adaptive fragmentation unit is further operable to
divide said second subframe into a third subframe and a fourth subframe; and
append a third trailer to said third subframe, said third trailer indicating that said third subframe precedes said last subframe in said fragmented frame.

10. A method of transferring data through a network by adaptively fragmenting frames of information into subframes, the method comprising:
accepting a first low-priority frame into a first input queue;
beginning transmission of said first low-priority frame from said first input queue;
accepting a first high-priority frame at a second input queue;
suspending transmission of said first low-priority frame upon acceptance of said first high-priority frame in said second input queue;
transmitting said first high-priority frame from said second input queue; and
continuing transmission of said first low-priority frame from said first input queue upon completion of transmission of said first high-priority frame from said second input queue.

11. The method of claim 10 wherein said suspending includes:
segmenting said first frame into a fragmented frame comprised of at least a first subframe and a second subframe;
appending a first trailer to said first subframe and completing transmission of said first subframe, said first trailer indicating that said first subframe precedes a last subframe of said fragmented frame.

12. The method of claim 11 wherein a second trailer is appended to said second subframe and said second subframe is transmitted, said second trailer indicating that said second subframe is said last subframe of said fragmented frame.

13. The method of claim 11 further including:
accepting a second high-priority frame into said second input queue;
segmenting said second subframe into a third subframe and a fourth subframe upon acceptance of said second high-priority frame in said second input queue; and
appending a third trailer to said third subframe, said third trailer indicating that said third subframe precedes said last subframe in said fragmented frame.

14. The method of claim 13 further including appending a third header to said third subframe, said third header indicating said third subframe follows said initial subframe in said fragmented frame.

15. The method of claim 13 further including, upon said acceptance of said second high-priority frame into said second input queue:
completing transmission of said third subframe from said first input queue;
transmitting said second high-priority frame from said second input queue; and
transmitting said fourth subframe from said first input queue upon completion of transmission of said second high-priority frame from said second input queue.

16. A data transfer device comprising:
a first input queue and a second input queue, wherein said first input queue is operable to accept a low-priority frame and said second input queue is operable to accept a high-priority frame;
an adaptive fragmentation unit operative to (i) suspend transmission of said low-priority frame upon acceptance of said high-priority frame in said second input queue; (ii) transmit said high-priority frame from said second input queue; and (iii) continue transmission of said low-priority frame from said first input queue upon completion of transmission of said high-priority frame from said second input queue.

17. The data transfer device of claim 16 wherein said adaptive fragmentation unit is further operable to:
segment said low-priority frame into a fragmented frame comprised of at least a first subframe and a second subframe;
append a first trailer to said first subframe and complete transmission of said first subframe, said first trailer indicating that said first subframe precedes a last subframe of said fragmented frame.

18. The data transfer device of claim 17 wherein said adaptive fragmentation unit is further operable to append a second trailer to said second subframe and to transmit said second subframe, said second trailer indicating that said second subframe is said last subframe of said fragmented frame.

19. A method for transferring data through a network having at least a plurality of subscriber nodes operatively connected to a network node, the method comprising:
accepting a first low-priority frame at a first subscriber node and initiating transmission of said first low-priority frame to said network node;
accepting a first high-priority frame at said first subscriber node;
suspending transmission of said first low-priority frame upon acceptance of said first high-priority frame at said first subscriber node;
transmitting said first high-priority frame from said first subscriber node to said network node;
accepting a second low-priority frame at said network node and initiating transmission of second low-priority frame to said first subscriber node;
accepting a second high-priority frame at said network node;
suspending transmission of said second low-priority frame upon acceptance of said second high-priority frame at said network node; and
transmitting said second high-priority frame from said network node to said first subscriber node.

20. The method of claim 19 further including:
continuing transmission of said first low-priority frame from said first subscriber node upon completion of transmission of said first high-priority frame; and
continuing transmission of said second low-priority frame from said network node upon completion of transmission of said second high-priority frame.

21. The method of claim 10 wherein said beginning transmission of said first low-priority frame includes transmitting a series of subframes of said first frame prior to transmission of said second frame, each of said subframes including a fragment header and a fragment trailer.

22. The data transfer device of claim 16 wherein said adaptive fragmentation unit is further operative to transmit a series of subframes of said first frame prior to transmission of said second low-priority frame, each of said subframes including a fragment header and a fragment trailer.

23. The method of claim 1 wherein said high-priority frame comprises a voice frame.

24. The method of claim 1 wherein said high-priority frame comprises a video frame.

25. The data transfer device of claim 6 wherein said high-priority frame comprises a voice frame.

26. The data transfer device of claim 6 wherein said high-priority frame comprises a video frame.

27. The method of claim 10 wherein said first high-priority frame comprises a voice frame.

28. The method of claim 10 wherein said first high-priority frame comprises a video frame.

29. The data transfer device of claim 16 wherein said high-priority frame comprises a voice frame.

30. The data transfer device of claim 16 wherein said high-priority frame comprises a video frame.

31. The method of claim 19 wherein said first high-priority frame comprises a voice frame.

32. The method of claim 19 wherein said first high-priority frame comprises a video frame.

33. A concentrator device interposed between a communication network and a plurality of digital subscriber lines, said concentrator device comprising:
a plurality of subscriber line interfaces operatively connected to said plurality of digital subscriber lines;
a network interface operatively connected to said communication network, said network interface receiving low-priority frames and high-priority frames from said communication network; and
a frame processing module operatively coupled to said plurality of subscriber line interfaces and to said network interface, said frame processing module including a fragmentation unit for fragmenting ones of said low-priority frames in response to receipt from said network interface of one or more of said high-priority frames.

34. The concentrator device of claim 33 wherein said fragmentation unit is operative to (i) segment a first of said low-priority frames into a fragmented frame comprised of at least a first subframe and a second subframe, (ii) transmit a first of said high-priority frames subsequent to transmitting said first subframe, and (iii) transmit said second subframe subsequent to transmission of said first of said high-priority frames.

35. The concentrator of claim 34 wherein said fragmentation unit is further operative to append a first identifying field to said first subframe and a second identifying field to said second subframe, said first and second identifying fields respectively indicating the relative position of said first subframe and said second subframe within said fragmented frame.

36. A method for transferring data through a network node operatively connected to a communications network and to a plurality of subscriber nodes, the method comprising:
receiving at said network node a first portion of a first low-priority frame transmitted by a first subscriber node;
receiving at said network node a first high-priority frame transmitted by said first subscriber node upon suspension of transmission of said first low-priority frame;
accepting, at said network node, a second low-priority frame provided by said communications network;
initiating transmission of said second low-priority frame from said network node to said first subscriber node;
accepting, at said network node, a second high-priority frame received from said communications network;
suspending transmission of said second low-priority frame upon acceptance of said second high-priority frame at said network node; and
transmitting said second high-priority frame from said network node to said first subscriber node.

37. The method of claim 36 further including:
receiving at said network node a second portion of said first low-priority frame transmitted by said first subscriber node upon completion of transmission of said first high-priority frame; and
continuing transmission of said second low-priority frame from said network node upon completion of transmission of said second high-priority frame.
